(19) United States
(12) Patent Application Publication
(10) Pub. No.: US 2005/0053421 A1
(43) Pub. Date: Mar. 10, 2005

(54) Positioning structure for door fastener

(76) Inventor: Shoei-Yuan Shih, Taipei Hsien (TW)

Correspondence Address: BIRCH STEWART KOLASCH & BIRCH, PO BOX 747, FALLS CHURCH, VA, 22040-0747, US

(21) Appl. No.: 10/601,621

(22) Filed: Jun. 24, 2003

(51) Int. Cl. F16B 21/00

(52) U.S. Cl. 403/326

(57) ABSTRACT

The invention provides a positioning structure for a door fastener, which is to encircle a positioning area on a metal case so as to provide a firm positioning to a door fastener with lodge-in space. The invention includes a vertical panel that meets the thickness of the lodge-in space, a through hole provided on the vertical panel, and an upper curb portion provided at the through hole on the vertical panel. Besides, two side curb portions are provided on the horizontal panel corresponding to the width of the door fastener; in all, the upper curb portion, two side curb portions, and the horizontal panel encircle a positioning area that can form a firm positioning for the door fastener when the door fastener is placed into the positioning area through the through hole.

### FIELD OF THE INVENTION

The invention relates to a positioning structure for a door fastener and, more particularly, to a door fastener that is applicable to a lodge-in space whose common specified thickness is 2 mm.

### BACKGROUND OF THE INVENTION

Referring to FIGS. 1 and 2, a conventional door fastener 20 includes a body 21 with proper thickness. Besides, a flange 22 is provided at one end of the body 21, and a hook 23 is provided at each of the two sides of the body 21. Also, a lodge-in space 26 whose common specified thickness is 2 millimeters (mm) is defined between the flange 22 and the hook 23. In addition, an accommodating slot is set inside the body 21 to facilitate the setting of a flexible hook 25 for making to-and-fro shifting therein, wherein two clamping arms 24 are provided at the front end of the flexible hook 25 in a wide-open manner. To assemble the door fastener 20, first, the door fastener 20 will go through a positioning hole on the vertical panel 11′ of the case 10′ and be positioned. Next, an interlocking fastener 31 is provided corresponding to the door body 30 to apply force on the clamping arms so that the door body 30 can be positioned in the case 10′ and form the door fastener 20. In general, there are two methods to position a door fastener 20 in the case 10′, which are described as below:
1) The first method is to provide a positioning hole on the vertical panel 11′ of the case 10′ for accommodating the door fastener 20, wherein the thickness of the vertical panel 11′ has to be 2 mm. However, this method is only applicable to a plastic case 10′, not a metal case 10. The reason for being inapplicable to a metal case 10 is that the thickness of the metal case 10 is commonly specified as 1 mm in this method, which is not the same thickness as the specified 2 mm of the lodge-in space 26. However, if the door fastener 20 is redesigned as 1 mm, then the lodge-in space 26 will not be strong enough to keep the stability.
2) In order to cope with the above-mentioned problem about the metal case 10, an improved method is proposed, which is to add a positioning area 13′ to the metal case 10, as shown in FIG. 2, and also add a plastic cover 40 on top of the positioning area 13′. By doing so, the thickness of the plastic cover 40 can meet the specified 2 mm of the lodge-in space 26. However, this method also requires an adequate space for assembling the plastic cover during the internal arrangement of the components of the metal case 10, or the situation may turn out to be that the shape and the specification of the plastic cover 40 all have to be changed due to position change. Therefore, not only will the assembly cost be increased, but the adaptability of the metal case 10 will also be in doubt.

The aforementioned two methods are proposed to provide a positioning structure for the door fastener 20 based on the 2 mm lodge-in space 26. But in fact, the door fastener 20 must preserve some certain degree of tolerance during the assembling process; otherwise, if the positioning is only done within the lodge-in space 26, the space cannot prevent the door fastener 20 from slanting or shifting because the rear body 21 does not offer any support. Therefore, the difficulty of the assembling job will be increased. Moreover, the clamping arms 24 are pretty fragile themselves, and if the assembling job is executed without paying attention to the shifting of the door fastener 20, then the damage on the door fastener 20 will be more likely to happen.

### SUMMARY OF THE INVENTION

The object of the invention is to solve the aforementioned problem that the door fastener cannot be installed to a metal case directly or that the plastic cover has to be added to the metal case. The improved method is to provide the case with a vertical panel that can meet the required thickness of the lodge-in space, wherein the vertical panel is integrally formed in a bending and overlapping manner with 2 mm thickness. Besides, an upper curb portion is provided at the through hole of the vertical panel, and two side curb portions are provided on a horizontal panel that is connected to the vertical panel and corresponding to the width of the door fastener. The curb portion, the two side curb portions and the horizontal panel encircle a positioning area that can stably perform a positioning job as soon as the door fastener has been placed through the through hole.

The object and technical contents of the invention will be better understood through the description of the following embodiments with reference to the drawings.

### BRIEF DESCRIPTION OF THE DRAWINGS

FIG. 1 is a schematic diagram showing a conventional door fastener with plastic case assembly.

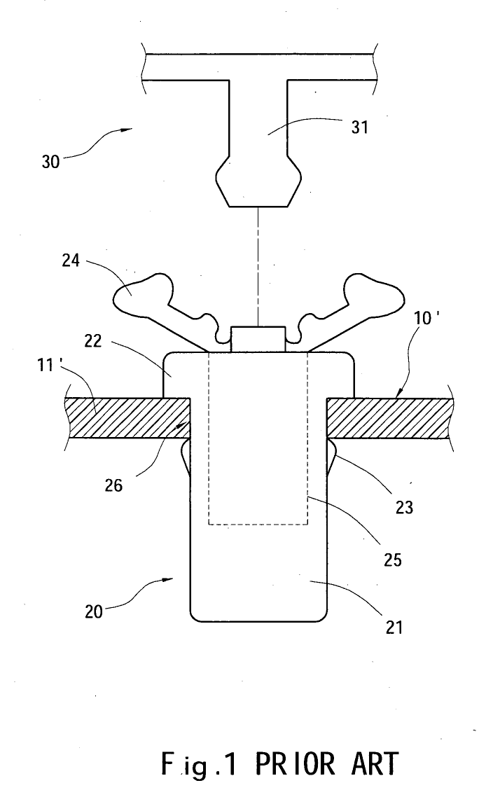

FIG. 2 is a schematic diagram showing a conventional plastic cover and door fastener with metal case assembly.

FIG. 3 is a schematic diagram showing the structure of the positioning area of the invention.

FIG. 4 is a schematic diagram showing the assembly of the door fastener of the invention.

FIG. 5 is a schematic diagram showing the top view of the door fastener assembly of the invention.

FIG. 6 is a schematic diagram showing the second structure of the positioning area of the invention.

FIG. 7 is a schematic diagram showing the third structure of the positioning area of the invention.

### DETAILED DESCRIPTION OF THE PREFERRED EMBODIMENTS

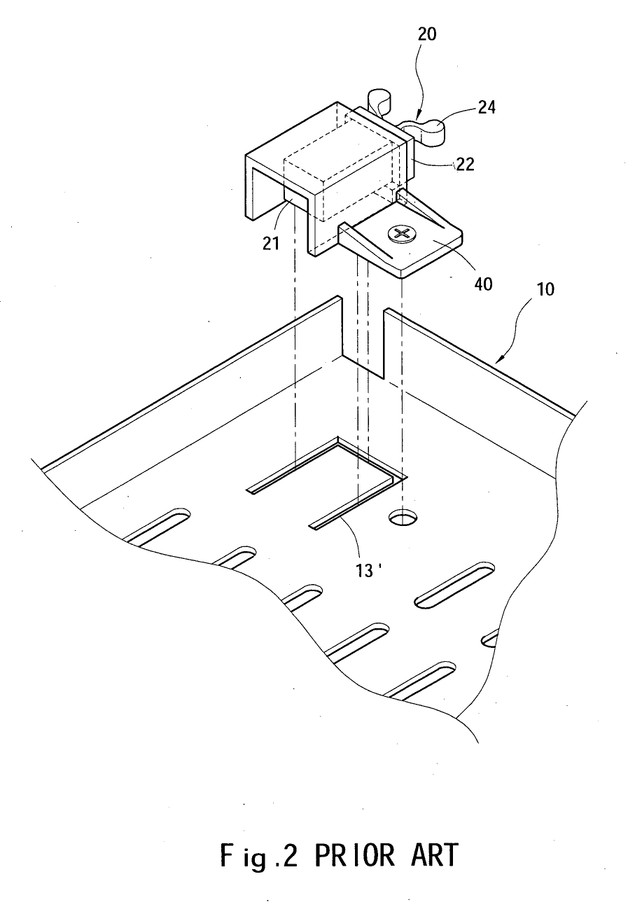

Referring to FIGS. 2, 3, and 4, they are schematic diagrams showing the structure of the positioning area 13 and the assembly of the door fastener 20 of the invention. As shown in the Figs., the invention provides an encircled positioning structure on a metal case 10 that can provide firm positioning to a door fastener 20 with lodge-in space 26. The positioning structure includes a vertical panel 11 that meets the required thickness of the lodge-in space 26 and a horizontal panel 12 that is vertically connected to the vertical panel 11. In addition, the common specified thickness of the lodge-in space 26 for the door fastener 20 is 2 mm, whereas the common specified thickness of the vertical panel 11 for the general metal case 10 is 1 mm. Therefore, a complementary portion 110 with 2 mm is integrally formed in a bending and overlapping manner on the vertical panel 11 so that the lodge-in space 26 of the door fastener 20 and the vertical panel 11 can form an interlocking relationship. Besides, a through hole 111 is provided on the vertical panel 11, while an upper curb portion 112 is provided at the through hole 111 of the vertical panel 11, and two side curb portions 121 are provided on the horizontal panel 12 corresponding to the width of the door fastener 20. In all, the upper curb portion 112, two side curb portions 121, and the horizontal panel 12 encircle a positioning area 13 that can perform firm positioning for the door fastener 20 as soon as the door fastener 20 has been placed into the positioning area 13 through the through hole 111.

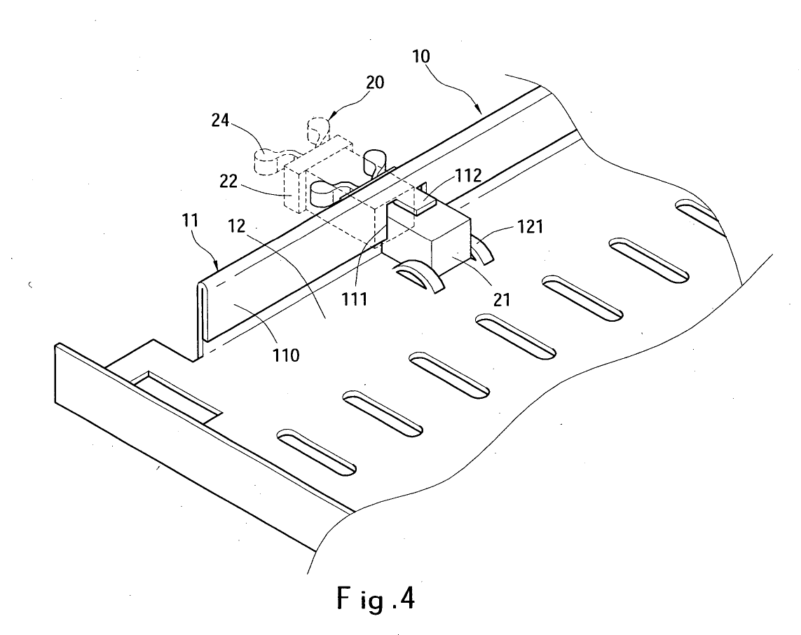

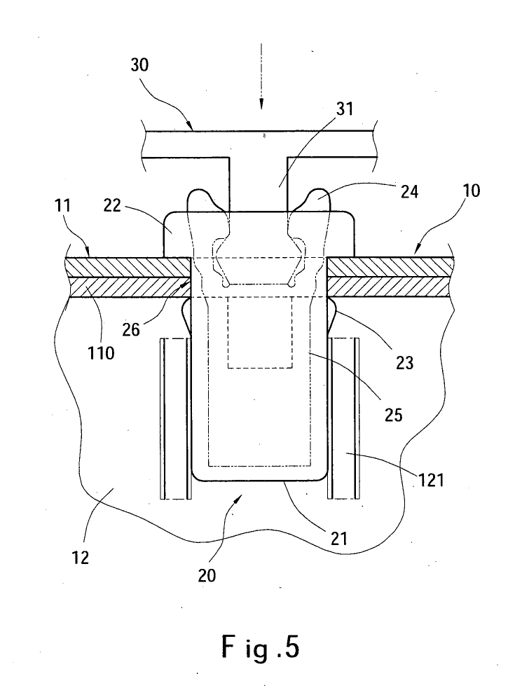

It is showed in FIGS. 4 and 5 that as soon as the door fastener 20 has been placed into the positioning area 13 through the through hole 111, the door fastener 20 and the vertical panel 11 can form an interlocking relationship because the thickness of the vertical panel 11 has meet the required 2 mm of the lodge-in space 26 and because the vertical panel 11 has been finished with the bending and overlapping process. Besides, a positioning area 13 that is encircled by the upper curb portion 112 and the side curb portions 121 has the same shape and dimension as the body 21 of the door fastener 20. Therefore, in addition to that the vertical panel 11 and the lodge-in space 26 formed by the flange 22 and the hook 23 can get a positioning from the interlocking fastener 31, the rear body 21 can be firmly positioned on the positioning area 13, which in turn allows the interlocking fastener 31 on the door body 30 to be pushed into the clamping arms 24 and then the flexible hook 25 will be activated for interlocking. However, the door fastener 20 will not be shifted; instead, the door body 30 corresponding to the case 10 will be activated more easily, and the clamping arms 24 of the door fastener 20 will not be pushed and therefore the damage on the door fastener 20 can be effectively avoided.

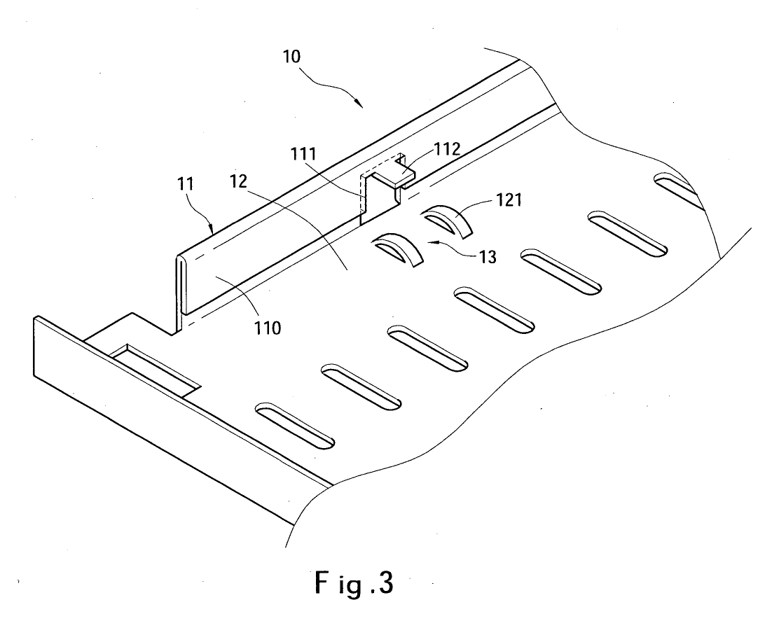

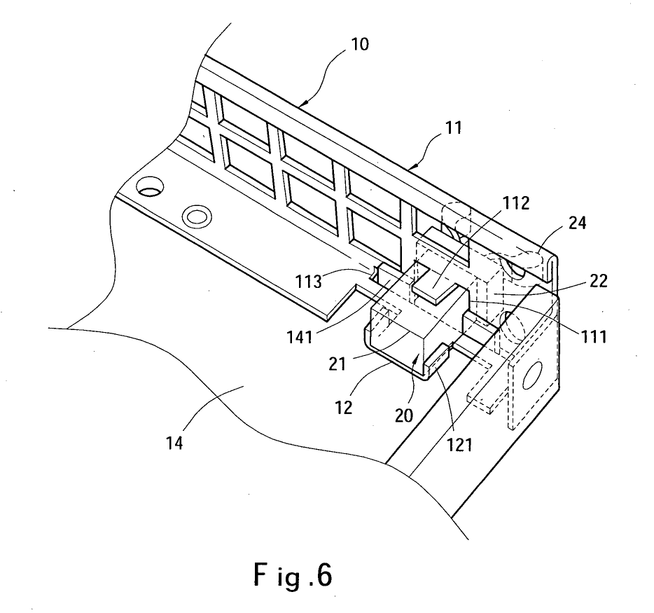

In FIGS. 3 to 5, the major portion being applied in the metal case 10 is the cover body of the metal case 10, while the vertical panel 11 and the horizontal panel 12 can be integrally formed in a vertically bending manner. However, if a hard disk rack is taken into consideration, the assembly position and method will have to be changed and thus the embodiment shown in FIG. 6 should be applied, which is a schematic diagram showing the second structure of the positioning area of the invention. In such case, the vertical panel 11 and the horizontal panel 12 can also be integrally formed in a vertically bending manner, whereas an opening 113 can be provided on the vertical panel 11 at two sides of the through hole 111, and a complementary portion 141 is provided at two sides of the through hole 111 with overlapping and upward bending on the bottom panel 14 of the case 10. In other words, the complementary portion 141 that is overlapped and bent starting from the bottom panel 14 and the vertical panel 11 will form a vertical panel 11 with 2 mm in thickness that is the same as that of the lodge-in space 26. Besides, the vertical panel 11 is extending inwardly at the through hole 111 to form a horizontal panel 12, followed by an upward bending to form a side curb portion 121. Also, the upper curb portion 112 bends above the through hole 111 and then encircles a positioning area 13.

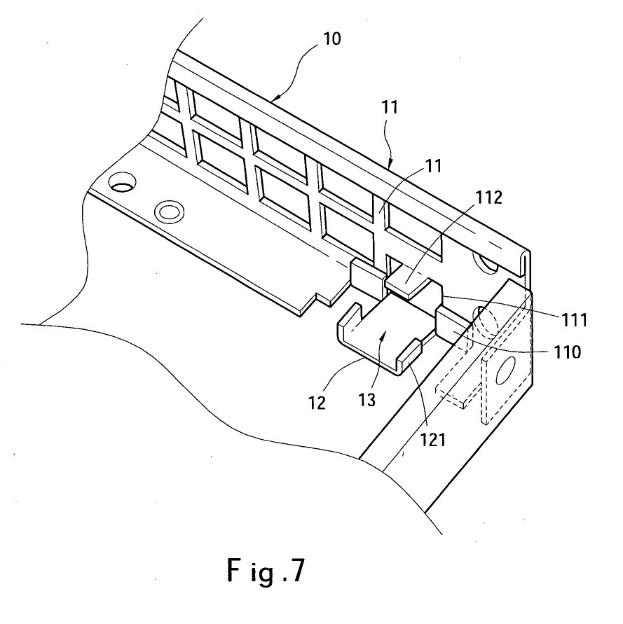

FIG. 7 is a schematic diagram showing the third structure of the positioning area 13 of the invention. As shown in FIG. 7, the difference between the embodiment in FIG. 7 and the embodiment in FIG. 6 is that the complementary portion 110 is integrally formed on the vertical panel 11 at two sides of the through hole 111 in an upward bending manner so as to meet 2 mm thickness of the lodge-in space 26. Besides, the vertical panel 11 is extending inwardly at the through hole 111 to form a horizontal panel 12, followed by an upward bending to form a side curb portion 121. Similarly, the upper curb portion 112 also bends above the through hole 111 and then encircles a positioning area 13.

1. A positioning structure for a door fastener, which is to encircle a positioning area on a metal case so as to provide a firm positioning to a door fastener with lodge-in space, including the following components:
a vertical panel that meets the thickness of the lodge-in space, through hole provided on the vertical panel, and an upper curb portion provided at the through hole on the vertical panel; and
a horizontal panel that is vertically connected to the vertical panel and two side curb portions that are provided on the horizontal panel corresponding to the width of the door fastener; in all, the upper curb portion, two side curb portions, and the horizontal panel encircle a positioning area that forms a firm positioning for the door fastener when the door fastener is placed into the positioning area through the through hole.

2. The positioning structure for a door fastener as claimed in claim 1, wherein the thickness of the lodge-in space of the door fastener is 2 millimeters (mm), whereas the thickness of the vertical panel is 1 mm; therefore, a complementary portion with 2 mm thickness is integrally formed in a bending and overlapping manner on the vertical panel so as to meet the thickness of the lodge-in space.

3. The positioning structure for a door fastener as claimed in claim 1, wherein the vertical panel and the horizontal panel can be integrally formed in a vertically bending manner.

4. The positioning structure for a door fastener as claimed in claim 1, wherein an opening can be provided on the vertical panel at two sides of the through hole, and a complementary portion is provided at two sides of the through hole in an overlapping and upward bending manner on the bottom panel of the case.

5. A door fastening apparatus, comprising:
a door fastener having a lodge-in space;
a positioning structure, said positioning structure including,
a vertical panel;
a through hole provided in the vertical panel;
an upper curb portion provided on the upper side of the through hole;
a horizontal panel connected to the vertical panel;
two side curb portions on said horizontal panel having a distance therebetween equal to a width of the door fastener;
said upper curb portion, said two side portions and said horizontal panel limiting movement of the door fastener so as to position the door fastener and prevent undesired movement.
